(19) United States
(12) Patent Application Publication
(10) Pub. No.: US 2005/0049355 A1
(43) Pub. Date: Mar. 3, 2005

(54) Flame retardant polymer composites and method of fabrication

(75) Inventors: Xinhe Tang, Vienna (AT); Klaus Mauthner, Vienna (AT); Ernst Hammel, Vienna (AT)

Correspondence Address: OSTROLENK FABER GERB & SOFFEN, 1180 AVENUE OF THE AMERICAS, NEW YORK, NY, 100368403, US

(73) Assignee: Electrovac Fabrikation Elektrotechnischer Spezialartikel GmbH

(21) Appl. No.: 10/922,446

(22) Filed: Aug. 20, 2004

Related U.S. Application Data
(63) Continuation-in-part of application No. PCT/IB03/01967, filed on Feb. 19, 2003.
(60) Provisional application No. 60/359,276, filed on Feb. 20, 2002.

(51) Int. Cl. C08K 3/04

(52) U.S. Cl. 524/496

(57) ABSTRACT

A flame retardant composite and a method for its fabrication are disclosed. The flame retardant composite shows both improved mechanical properties and flame retardancy. The composite comprises a matrix material and carbon nanotubes, such as single walled nanotubes, multi-walled nanotubes or fishbone-like graphitic cylinders, exhibiting a hollow core. For example, the outer diameters of the carbon nanofibers may be in the range from 1.2 to 500 nm. For example, a carbon nanotube may be incorporated as a layer in or on the surface of the composite. The method of fabrication of the composite may include a step of de-agglomeration.

### RELATED APPLICATION

This application is a continuation-in-part of PCT International Application No. PCT/IB03/01967, filed Feb. 19, 2003, which claims the benefit of U.S. Provisional Application No. 60/359,276, filed Feb. 20, 2002.

### FIELD OF THE INVENTION

The present invention relates to a flame retardant polymer composite and a method for its fabrication. One embodiment is a flame retardant polymer composite reinforced by embedded carbon nanotubes that impart flame retardancy and improved mechanical properties. Flame retardant polymer composites made according to the method of fabrication have a higher impact strength and stiffness than other flame retardant polymer composites.

### BACKGROUND OF THE INVENTION

It is known that the addition of fibers to a matrix material can substantially improve the mechanical properties of a part or structure compared to the mechanical properties of the matrix material without the addition of fibers. For example, fibers of straw were used in mud bricks for residential construction from the time that civilized people first began constructing villages. Also, fiberglass, a composite of a polymer with glass fibers, is used ubiquitously in residential and commercial construction and in the transportation sector, providing light weight, high strength and low cost. Composites comprising a polymer matrix and carbon fiber reinforcement are also known in the art.

Many polymers are inflammable (i.e. subject to combustion and burning if exposed to high temperatures or flames). Textiles, materials used in transportation, and materials for construction, remodeling or repair of residential or commercial real estate must meet certain minimum safety standards, including increasingly stringent fire safety codes. Polymeric materials and composites based on polymers or epoxy resins offer light weight, durability, and low cost of a large number of applications in textiles, and in construction, including but not limited to waste pipes, furniture, clothing, insulation, wall coverings, and load bearing members. Polymers that are inflammable at temperatures that can be expected to be encountered in the service life of a product, part or structure either by accident or design are undesirable. Furthermore, some polymers emit noxious or toxic fumes when burning, which can substantially increase the number of injuries and deaths, as a result of an accidental combustion of the polymeric material. Furthermore, materials based on polymers or epoxy resins require flame retardancy in transportation, e.g. aircraft parts and automobile parts, and in construction of residential and commercial buildings, must be designed to. In addition, polymeric textiles require flame retardancy for clothing, including protective helmets, flame retardant clothing, flame retardant and durable upholstery, and flame retardant and ballistic-impact-resistant structures, vests and shelters.

The typical solution to the problem of inflammability of epoxy resins and polymeric materials used in these applications and others is to combined flame retardant additives with the epoxy resin, curing agent or polymer matrix of the material or composite. The term flame retardant is being used herein to mean the ability to retard the spread of an existing flame, to deter the ignition of a polymer-based material exposed to a flame, and to resist degradation of a polymeric-based materials mechanical properties for a period after exposure to heat and flame in a fire. Generally, one or more specific additives are selected for particular polymeric materials and can reduce inflammability, prevent combustion, reduce toxic emissions, cause the material to self-extinguish and/or reduce the subsequent rapid spread of fire once combustion occurs. For example, flame retardants include halogen-containing or phosphorous-containing organic compounds. Once exposed to high temperatures the polymer composites with additives can be a source of non-inflammable gases, phosphoric acid or some other blowing agent. A typical method of protection involves the rapid production of a multicellular foam at the surface of the polymer composite material at an elevated temperature, which acts as a non-inflammable barrier between the source of heat or flame and the polymer composite material.

More specifically, fire retardant grades of polymeric materials and composites based on polymer or epoxy resin matrices may be obtained by the incorporation of conventional additives which are generally either inorganic, for example magnesium hydroxide, or halogenated organic materials for example tris(p-chloroethyl) phosphate with antimony oxide as synergist. The inorganic flame retarding additives, if used in sufficiently large quantities, can adversely affect the physical and mechanical properties of the material or composite. The halogenated, organic additives resist ignition and retard combustion, but if exposed to an external flame, these additives can cause emission of toxic and extremely corrosive gases, which can result in serious injuries and severe degradation of aluminum and steel structures.

For example, U.S. Pat. No. 4,014,829, Baird et al., issued on Mar. 29, 1977, and British Pat. Specification No. 1,438,067, published on Jun. 3, 1976, disclose flame retardant textile fibers which are obtained by impregnating poly(m-phenylene isophthalamide) fibers with tetrakis hydroxymethyl phosphonium compound and a resin containing active hydrogen (e.g., melamine-formaldehyde resin), and heating the impregnated fibers to form a cross-linked reaction product of the tetrakis hydroxymethyl phosphonium compound and the resin in the fibers. Poor fiber qualities and insufficient resistance to heat shrinkage are disadvantages of this method.

U.S. Pat. No. 4,008,345, Imanaka et al, issued on Feb. 15, 1977, discloses a process for fire-proofing treatment of shaped articles of aromatic polyamide which comprises contacting a shaped article of an aromatic polyamide with an aqueous solution of a halogen- and sulfur-free, phosphorus-containing inorganic acid, drying at a temperature ranging from about 150.degree C., and then post-treating at a temperature ranging from about 300.degree. C. to about 450.degree. C. This method reduces the quality of fibers and provides inadequate protection against heat shrinkage and inflammability.

An improved non-inflammable epoxy resin was obtained by incorporating polyvalent alcohol, as a source of carbon, in epoxy resin in combination with a source of phosphorous and a source of non-inflammable gases. See U.S. Pat. No. 3,981,832. Upon heating, the polyvalent alcohol, as a source of carbon atoms, entered into an esterifying reaction with the phosphoric acid, which was produced by heating the phosphorous containing compounds. Immediately, the heat caused the ester to decompose, producing water, carbon dioxide, and other non-inflammable gases as bi-products of the reaction, which in combination with the other source of non-inflammable gases produces a foaming, wet barrier to the source of heat or flames. In addition, the phosphoric acid is recovered during the decomposition of the ester, and it continued to react, so long as the polyvalent alcohol was available to continue to esterifying reaction and the temperature remained sufficiently high to decompose the complex ester created. The chemical reactions at high temperature rendered the epoxy resins non-inflammable in a higher degree than known before, but the reaction was limited to articles made from epoxy resins and still required additives for the source of phosphoric acid and non-inflammable gases. The disclosed composition rendered molded articles non-inflammable without increasing the melting temperature of the disclosed epoxy resins or curing against above room temperature, reducing processing costs; however, glass fibers, not the hydrocarbon used as the source of carbon, were used to reinforce the epoxy resin.

Another solution to make a thermosetting polymer material flame retardant was to incorporate a low-melting-temperature glass powder and a blowing agent in the polymer matrix, which caused a layer of the glass to form at the surface of the polymer, reducing the amount of smoke produced compared to the use of halogen-producing additives. See U.S. Pat. No. 3,933,689. Again, the low-melting-temperature glass powder was not used to improve the mechanical properties of the polymer.

One problem not generally addressed is the deleterious effect of each of the foregoing additives on the notched impact strength, toughness, strength and stiffness of the polymer composite. Another problem of adding halogen-containing or phosphorous-containing compounds is that these organic compounds often diffuse away over time, reducing the effectiveness of the flame retardancy over time. Yet another problem results from fixing halogen atoms into the epoxy resin or curing agent, which can cause an increase in the melting point of the epoxy resin or the curing agent. This can require the use of solvents to be able to mix the epoxy resin and curing agent at room temperature or the use of elevated temperatures for mixing, which add substantial costs to the production of parts or structures. Also, some of these additives reduce the combustibility, but nevertheless the polymer or polymer composite produces smoke, noxious fumes or toxic fumes at elevated temperatures.

An additional problem results from the addition of fibrous reinforcements, which act as a wick in polymer matrix materials. See U.S. Pat. No. 6,196,832. Glass fibers, ceramic fiber and carbon fiber can serve as heat-resistive wicks. Carbon fibers are particularly suited, because they are often both porous and heat-resistive, drawing up the liquified inflammable polymer, which vaporizes from the surface and ignites on contact with a flame. This wicking effect increases the difficulty in extinguishing combustion of a polymer matrix composite material. Also, it can reduce the effectiveness of additives for flame retardancy by wicking inflammable vapors through a flame retardant surface layer.

Fiber-reinforced polymer composite materials are being used to an increasing extent as replacements for steel and other structural materials, because fiber-reinforced polymer composites offer the advantages of lighter weight, improved corrosion resistance, and reduced maintenance requirements. Matrix resins used in such composites include, but are not limited to, polyesters, epoxy resins, phenolic resins, bismaleimides, and polyphenylene sulfides. Reinforcing materials include glass fiber, carbon fiber, Kevlar® fiber (a registered trademark of E.I. du Pont Nemours and Company), and Spectra® fiber (a registered trademark of AlliedSignal, Inc.). See U.S. Pat. No. 5,236,773, which discloses fire-resistant barrier materials include ceramic fabrics, ceramic coatings, and intumescent (swelling or foaming) coatings, and combinations of ceramic coatings with intumescent coatings to protect carbon-fiber reinforced polymer composites (including graphitic carbon-fibers). Also, U.S. Pat. No. 5,236,773 shows that graphitic carbon-fiber reinforcement provides little, if any, increased flame retardancy (e.g. graphite fiber reinforced epoxy resin composite and graphite fiber reinforced vinyl ester resin composite) compared with glass fiber reinforced polymer composites. Residual flexural strength is particularly poor for graphite fiber reinforced epoxy resins. The ceramic coatings with intumescent coatings add significant costs and parasitic weight to the structures. Also, ceramic coatings are brittle and can be undermined by the impact of a foreign object with the coated structure (e.g. an aircraft) and as a result of earthquakes.

Flame retardancy is experimentally determined by a series of standard test procedures, some such tests include Smoke Generation and Combustion Gas Products, ASTM E-662; and Residual Flexural Strength, ASTM D-790; which are incorporated herein by reference in their entirety. Also, additional inflammability tests are disclosed by Carlos J. Hilado in Inflammability Handbook for Plastics, 4th Ed., Technomic Publishing Co., Lancaster, Pa. (1990), hereinafter referred to as “Hilado”, including tests for smolder susceptibility of home furnishings, ignitability (e.g. ASTM D 1929), flash-fire propensity (e.g. Douglas flash-fire test), flame spread (e.g. ASTM E 84 and ASTM E 162), heat release (e.g. ASTM E 906 and ASTM E 5), fire endurance (e.g. ASTM E 119), ease of extinguishment (e.g. ASTM D 2863), smoke evolution (ASTM E 662 and ASTM D 2843), toxic gas evolution (German DIN 53436), and corrosive gas evolution (French CNET test). On page 108 of Hilado a chart of the characteristics of certain sources of ignition are shown, and this is incorporated herein by reference.

### SUMMARY OF THE INVENTION

The present invention is directed to an improved flame retardant polymer composite and a method for its fabrication, which not only inhibits combustion, rendering the polymer composite non-inflammable or substantially reducing composite inflammability, but also improves the mechanical properties of the polymer composite. Preferably, a flame retardant polymer composite reinforced by carbon nanotubes retains some of its strength, stiffness, and toughness for a significant duration during exposure to high temperatures. Furthermore, the flame retardant properties of the carbon nanotubes eliminates the problem of wicking. The inventor's use of the terms flame retardant, flame retardance, and flame retardancy should be understood to include flame resistance and fire resistance, as these terms are commonly used in the art.

In one preferred embodiment of the invention a polymer composite comprises a polymer and a plurality of carbon nanotubes as reinforcements within the polymer composite. In this particular embodiment, a process mixes the plurality of carbon nanotubes into the polymeric matrix material, reinforcing the polymer matrix and rendering the composite flame retardant and antistatic. This embodiment of the invention may comprise additional additives, such as stabilizers, mold releasing agents, lubricants, antistatic agents, pigments, ultraviolet absorbers, organic halogen flame retardants, and inorganic flame retardants. The resulting composition may be further processed including, but not limited to, extruding, molding stamping, expanding, foaming and trimming. Following any subsequent processing, the resulting article or structure retains at least some of the improved mechanical properties and flame retardancy contributed by the addition of the carbon nanotubes.

In an alternative embodiment, the carbon nanotubes are incorporated within a polymer as reinforcing fibers at a concentration sufficient to provide a level of fire retardancy desired for a particular application. The level of fire retardancy required is set by statute, building codes, federal or state guidelines or corporate policy. The level of fire retardancy obtained for a specific polymer matric with a specific volume or weight percent of carbon nanotubes that are incorporated by a specific process is easily determined using the tests that have been incorporated herein by reference that are found in the background section. In a typical embodiment, the polymer is melted in a compound engine and mixed therein with the carbon nanotubes. Preferably, water and other gases are removed or degassed to prevent the formation of voids in finished products, which can reduce fatigue life and strength. In one embodiment, the mixture is fed to an extruder and extruded into filaments or sheets. In an alternative embodiment, the carbon nanotubes are mixed directly in an extruder together with a polymeric material. In either embodiment, carbon nanotubes will typically be added to the polymer in a concentration in a range between about 10% and 60% by volume. Typically, 25% by volume of nanotubes in the surface layer of polymer resin matrix is sufficient to impart excellent flame retardancy. However, some beneficial fire retardancy is obtained with as little as 1% by volume of carbon nanotubes.

In an alternative embodiment, the carbon nanotubes are preferentially distributed with a higher density near the surface of a composite structure. In yet another embodiment the carbon nanotubes reinforce polymer filaments, which are used to produce textiles. In this embodiment the longitudinal axis of the carbon nanotubes are oriented preferentially along the longitudinal axis of the polymer filaments. These composite filaments are both non-inflammable and have excellent mechanical properties.

One object of the invention is to reduce the inflammability of the polymer composite. Another object of the invention is to improve mechanical properties of the composite including, but not limited to, the strength, toughness, impact resistance, and stiffness. Yet another object of the invention is to retain some residual tensile strength during a fire.

In another preferred embodiment of the invention, the carbon nanotubes are not incorporated within the matrix of a polymer, but the carbon nanotubes are incorporated within a textile including both polymeric filaments and filaments of the carbon nanotubes. In one particular embodiment, the filaments of carbon nanotubes are coated with a thin coating of polymeric material, which can be the same polymeric material comprising the unreinforced polymeric filaments or a different polymeric material than the unreinforced polymeric filaments. In one specific example, an aramid filament is reinforced with carbon nanotubes that are coated with an aramid material to produce a protective vest that is both highly resistant to inflammability and resists ballistic impacts. For example, a “bulletproof vest” provides protection from the ballistic impact of bullets and shrapnel, including both flame retardancy and protection from a ballistic projectile. Alternative embodiments include, but are not limited to, protective helmets, flame retardant clothing, flame retardant and durable upholstery, and flame retardant and ballistic-impact-resistant structures and shelters.

In yet another embodiment of the invention, the carbon nanotubes are impregnated within and around a cotton textile. In an alternative embodiment, the carbon nanotubes are impregnated within and around a polymeric textile. In a specific embodiment, the impregnated textile can be subsequently incorporated as a layer within a composite structure. For example, the impregnated textile can be incorporated as a layer in a multilayer panel with an epoxy resin matrix. In one specific embodiment, the multilayer panel is prepared by hand lay-up, is enclosed in a vacuum bag, and is cured in an autoclave to yield a high-quality composite panel that has good tensile strength, flame retardancy, and antistatic properties.

### BRIEF DESCRIPTION OF THE FIGURES

For the purpose of illustrating the invention, representative embodiments are shown in the accompanying figures, it being understood that the invention is not intended to be limited to the precise arrangements and instrumentalities shown.

FIG. 1 is a photograph of a cotton textile impregnated with carbon nanotubes, which is shown to be resisting ignition while being exposed to the flame of a propane torch for a duration of less than 10 seconds (FIG. 1A) and between 45 seconds to one minute (FIG. 1).

FIG. 2 is a photograph of a cotton textile impregnated with carbon black, which has ignited after exposure to the flame of a propane torch for less than 10 seconds (FIG. 2B) and just before ignition (FIG. 2A).

FIG. 3 is a photograph of a cotton textile, which has ignited immediately after exposure to the flame of a propane torch (FIG. 3A) and with the flame fully developed and consuming the cotton textile at 45 seconds (FIG. 3B).

### DETAILED DESCRIPTION OF THE PREFERRED EMBODIMENTS

The present invention will now be described in detail for specific embodiments of the invention. These embodiments are intended only as illustrative examples and the invention is not to be limited thereto.

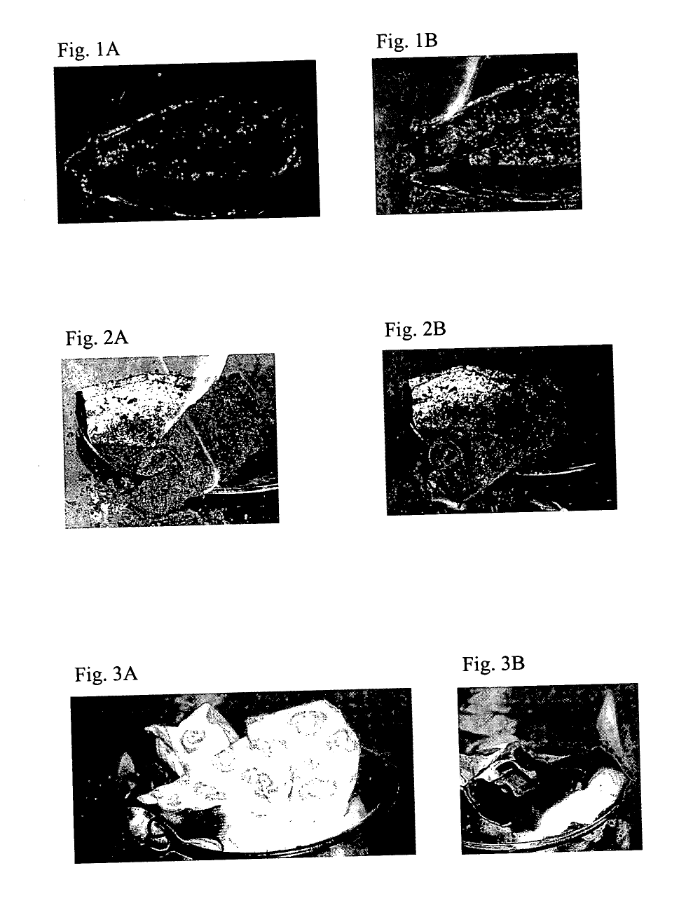

One embodiment of the present invention is shown in FIG. 1, which shows a cotton textile that has been impregnated by carbon nanotubes. Carbon nanotubes were mixed with water forming a slurry. Then, the textile was immersed in the slurry, and dried in air. The amount of water used was not critical to the impregnation of the textile, and any quantity of water that makes a slurry could have been used. Indeed, it is possible to impregnate the textile without using any solvent; however, it would be expected that the effectiveness of the flame retardancy could be diminished if the carbon nanotubes were not distributed throughout the textile. Alternatively, the slurry or dry carbon nanotubes could be sprayed onto the textile. However, without limiting the invention in any way, it is believed that the presence of a solvent, such as water, and the type of solvent used can improve the uniformity of carbon nanotube distribution, providing enhanced flame retardancy.

In a preferred embodiment, the carbon nanotubes are incorporated within the polymer as reinforcing fibers. For example, in oriented polyolefins, which typically have a tensile strength of about 250 N/mm², the addition of carbon nanotubes improves the tensile strength by nearly a factor of two, e.g. 400 N/mm². The inventors believe that this improvement in strength is caused by the network of fibers within the composite and the oriented crystallization of the polyolefin resin by nucleation on the carbon nanotubes, which provide a template for crystal growth.

In one embodiment of a flame retardant polymer composite, the carbon nanotubes are selected from single walled nanofibers, multi-walled nanofibers, or fishbone-like graphitic cylinders, exhibiting a hollow core in diameters in the range from 1.2 to 500 nm as an outside diameter. Typically, single walled carbon nanofibers are in the lower end of this range, whereas multi-walled carbon nanofibers and fishbone-like graphitic cylinders throughout the entire range, depending on the processing conditions during fabrication of the carbon nanofibers and subsequent processing conditions.

Typically, exposure of ultraviolet (UV) light degrades polymers, particularly if bromide flame retardant additives are used. Exposure of a carbon nanotube protected polymeric materials to the UV light of a Xenon light for one month showed no degradation of the physical or mechanical properties of the polymer-carbon nanotube composite. Without limiting the invention, the inventors believe that the carbon nanotubes absorb the UV light preferentially, protecting the polymeric matrix.

In another embodiment, a multilayered compound structure is fabricated using extrusion and lamination techniques common in the art, wherein a resin sheet layer is sandwiched between thin layers of resin mixed with carbon nanotubes. In a specific embodiment of this invention, a thin decorative surface layer is added on a surface layer of resin mixed with carbon nanotubes. When exposed to a flame, the thin decorative layer vaporizes, but the layer containing carbon nanotubes protects the underlying resin sheet layer from damage by the flame for up to several minutes. In an alternative embodiment, multiple, alternating layers can be used to impart greater flame retardancy and more isotropic mechanical properties. In one particular embodiment, the polymer matrix is polyoxymethylene (POM) and carbon nanotubes are added in a range between about 0.1% and 60% by volume, preferably from 1 to 40% by volume. More preferably, 25% by volume of carbon nanotubes are added to POM with directionally oriented fibers in the top surface that have an orientation 90 degrees from the direction of the oriented fibers in the bottom surface, and the POM sheet layer is twice as thick as the POM and fiber layers that it is sandwiched between. This particular embodiment provides adequate strength, toughness, and fire retardancy without any additional fire retardant additives, and is useful in parts requiring a wide operating temperature range, e.g. from −100 to +400° C. The selection of a volume percentage of carbon nanotubes in the external layers can be used to regulate the coefficient of thermal expansion of the parts, if compatibility with other parts is desired. Furthermore, the processing into sheets provides both a carbon nanotube orientation and the shear forces necessary to cause de-agglomeration of the carbon nanotubes.

In yet another embodiment, the dispersion of nanotubes is caused by a separate de-agglomeration step. In one specific embodiment, the carbon nanotubes are treated with an acid, e.g. nitric acid, to create functional groups on the carbon nanotube surface, e.g. carboxylic/acidic functional groups. Then, the carbon nanotubes are rinsed in a solvent, e.g. water, alcohol. The rinsing step may be repeated, including alternating solvents, until the nitric acid is rinsed from the carbon nanotubes. The treated carbon nanotubes can then be dispersed in a solvent using a dispersant, e.g, polyimine derivatives, wherein stirring yields a homogenous slurry and re-agglomeration is prevented. In yet another specific embodiment, stirring is enhanced using ultrasound.

It should be understood that each embodiment of a method for incorporation of carbon nanotubes within a polymer matrix comprises a specific resin, additives, specific mixing machines, rates of mixing, enhancement by ultrasound, temperatures, curing times, addition of solvents and other variables, which are specific to particular polymer resins. The specific polymers and resins available are known in the art and curing times and temperatures are readily available or determinable. The inventors have included herein some of the preferred methods for de-agglomeration: using solvents, acids to form functional groups that provide dispersal, spraying, extrusion, mixing and enhanced mixing.

1. A flame retardant polymer composite, comprising:
a polymer containing substantially no halogen-containing organic compounds; and
a plurality of carbon nanofibers incorporated with the polymer such that the polymer is rendered flame retardant according to industrial standards for flame retardancy without the addition of halogen-containing organic additives, wherein the nanofibers are incorporated with the polymer in a manner selected from the group consisting of intermixing the carbon nanofibers within the polymer, concentrating the carbon nanofibers near the surface within the polymer, bonding carbon nanofibers to the surface of the polymer and combinations thereof.

2. The composite of claim 1, wherein the nanofibers are incorporated such that substantially no wicking occurs.

3. The composite of claim 1, wherein the composite retains for a substantial duration at least a portion of the composite stiffness during exposure to high temperatures such that the stiffness of the composite during exposure to high temperatures that would substantially degrade the performance of the polymer without carbon nanofibers incorporated within the polymer remains greater than the stiffness of the polymer without carbon nanofibers for a substantial duration.

4. The composite of claim 1, wherein the carbon nanofibers are incorporated by intermixing, and the nanofibers are added to the polymer in a range from 10% to 60% by volume of the composite.

5. The composite of claim 1, wherein the carbon nanofibers are incorporated by intermixing and concentrating the carbon nanofibers in a surface layer near the surface within the polymer such that the carbon nanofibers have a concentration in the surface layer of the composite of at least 1% by volume of the surface layer of the composite.

6. The composite of claim 5, wherein the carbon nanofibers have a concentration in the surface layer of the composite of at least 25% by volume of the surface layer of the composite.

7. The composite of claim 3, wherein the carbon nanofibers are incorporated by intermixing and concentrating the carbon nanofibers in a surface layer near the surface within the polymer such that the carbon nanofibers have a concentration in the surface layer of the composite of at least 25% by volume of the surface layer of the composite.

8. The composite of claim 7, wherein the concentration of the carbon nanofibers is greater in the surface layer of the composite than in other portions of the composite.

9. The composite of claim 6, wherein the concentration of the carbon nanofibers is greater in the surface layer of the composite than in other portions of the composite.

10. The composite of claim 5, wherein the concentration of the carbon nanofibers is greater in the surface layer of the composite than in other portions of the composite.

11. The composite of claim 4, wherein the concentration of the carbon nanofibers is greater in the surface layer of the composite than in other portions of the composite.

12. The composite of claim 1, further comprising additives selected from the group of additives consisting of stabilizers, mold releasing agents, lubricants, antistatic agents, pigments, ultraviolet absorbers, inorganic flame retardants and combinations thereof.

13. The composite of claim 12, wherein the additives selected include pigments, ultraviolet absorbers and inorganic flame retardants.

14. The composite of claim 1, wherein the polymer is made of a polyolefin resin.

15. The composite of claim 1, wherein the polymer is of a polyoxymethylene.

16. The composite of claim 1, wherein the polymer is of an aramid.

17. The composite of claim 14, wherein the carbon nanofibers are at least partially oriented in a preferred direction and provide a nucleation template for crytallization of the polyolefin resin.

18. The composite of claim 1, wherein the carbon nanofibers are of single walled, multi-walled or fishbone-like graphitic tubes having a hollow core and outer tube diameters in a range of 1.2 to 500 nm.

19. The composite of claim 18, wherein at least a portion of the carbon nanofibers are fishbone-like graphitic tubes.

20. The composite of claim 18, wherein the composite is formed into filaments.

21. The composite of claim 17, wherein the preferred direction is in the direction along the longitudinal axis of the filaments.

22. The composite of claim 20, wherein the filaments are woven into a textile.

23. The composite of claim 18, wherein the composite is formed into a layer.

24. A method for fabricating a flame retardant composite from carbon nanofibers comprising:
treating the carbon nanofibers with an acid, creating functional groups;
rinsing the carbon nanofibers in a solvent;
dispersing the carbon nanofibers in a slurry; and
forming at least one flame retardant layer comprising dispersed carbon nanofibers.

25. A structural component comprising multiple layers, at least one of the multiple layers including the composite of claim 1, wherein the structural component is capable of operating within a temperature range from −100 to +400 degrees centigrade with substantially no degradation in stiffness and toughness over the life of the structural component, and the structural component is fire retardant.

26. The structural component of claim 25, wherein the composite of claim 1 forms an outer layer such that the structural component is fire retardant without addition of halogen-containing or phosphorus-containing additives.
